(19) United States
(12) Patent Application Publication
(10) Pub. No.: US 2026/0302271 A1
(43) Pub. Date: Oct. 1, 2026

(54) POWER GENERATION CELL AND FUEL CELL STACK

(71) Applicant: Honda Motor Co., Ltd., Tokyo (JP)

(72) Inventors: Suguru Omori, Saitama (JP); Shun Hattori, Saitama (JP); Toshinobu Mito, Saitama (JP); Kenta Watanabe, Saitama (JP)

(21) Appl. No.: 19/577,335

(22) Filed: Mar. 24, 2026

(30) Foreign Application Priority Data
Mar. 28, 2025 (JP) 2025-056683

(51) Int. Cl. H01M 8/025; H01M 8/0258; H01M 8/1004; H01M 8/241

(52) U.S. Cl. CPC H01M 8/025; H01M 8/0258; H01M 8/1004; H01M 8/241

(57) ABSTRACT

A power generation cell including a membrane electrode structure having a membrane electrode assembly and a frame member supporting the membrane electrode assembly, and a pair of separators forming flow paths between the separators and the membrane electrode structure. Each of the flow paths includes a central flow path and adjacent flow path formed in a first region located in a central of the separators and a second region adjacent to the first region, respectively. Each of the separators includes protruding portions having a substantially cylindrical shape protruding toward the membrane electrode structure in the second region and spaced apart from the membrane electrode structure by a thickness corresponding to gas diffusion layers of the membrane electrode structure, and ends of the gas diffusion layers are located within the second region.

### CROSS-REFERENCE TO RELATED APPLICATION

This application is based upon and claims the benefit of priority from Japanese Patent Application No. 2025-056683 filed on Mar. 28, 2025, the content of which is incorporated herein by reference.

### BACKGROUND OF THE INVENTION

### Field of the Invention

This invention relates to a power generation cell and a fuel cell stack.

### Description of the Related Art

In recent years, technological developments have been made on a fuel cell that contribute to energy efficiency in order to ensure access to energy that is affordable, reliable, sustainable and advanced by more people. As a conventional technology related to this type of fuel cell, a fuel cell has been known in which a joined body consisting of an electrolyte membrane and anode-side and cathode-side catalyst layers is sandwiched between a pair of separators through anode-side and cathode-side gas diffusion layers. Such a fuel cell is described in, for example, Japanese Unexamined Patent Publication No. 2019-215971 (JP2019-215971A). In the fuel cell described in JP2019-215971A, the gas diffusion layers and the joined body are supported inside a frame-shaped resin sheet.

In such a fuel cell, a narrow space in which generated water tends to accumulate is likely to be formed between the separator and the resin sheet around the end portion of the gas diffusion layer, and when the generated water stagnates, there is a risk that the electrolyte membrane may deteriorate.

### SUMMARY OF THE INVENTION

An aspect of the present invention is a power generation cell including: a membrane electrode structure including a membrane electrode assembly and a frame member supporting a peripheral edge portion of the membrane electrode assembly, the membrane electrode assembly having an electrolyte membrane, a first gas diffusion electrode layer disposed along one surface of the electrolyte membrane, and a second gas diffusion electrode layer disposed along another surface of the electrolyte membrane; and a separator including a first separator and a second separator, the first separator being disposed facing one surface of the membrane electrode structure so as to form a first flow path through which a first reaction gas flows between the first separator and the membrane electrode structure, the second separator being disposed facing another surface of the membrane electrode structure so as to form a second flow path through which a second reaction gas flows between the second separator and the membrane electrode structure. The first gas diffusion electrode layer includes a first gas diffusion layer to which the first reaction gas is supplied, and a first electrode catalyst layer disposed between the electrolyte membrane and the first gas diffusion layer, the second gas diffusion electrode layer includes a second gas diffusion layer to which the second reaction gas is supplied, and a second electrode catalyst layer disposed between the electrolyte membrane and the second gas diffusion layer, each of the first flow path and the second flow path includes a central flow path formed in a first region located at a central portion of the separator, an adjacent flow path formed in a second region adjacent to the first region, and an end flow path formed in a third region between a communication hole for a gas supply and discharge penetrating the separator and the second region, each of the first separator and the second separator has a plurality of protruding portions having a predetermined height of a substantially cylindrical shape protruding from each of the first separator and the second separator toward the membrane electrode structure in the second region, the predetermined height is set such that the plurality of protruding portions are spaced apart from the frame member by an amount corresponding to a thickness of each of the first gas diffusion layer and the second gas diffusion layer, and an end portion of the first gas diffusion layer and an end portion of the second gas diffusion layer are located within the second region.

Another aspect of the present invention is a fuel cell stack including: a cell stacked body having the above power generation cell, that is, a plurality of the power generation cells stacked in a predetermined direction; and an end unit disposed around the cell stacked body and configured to hold the cell stacked body in a state where a pressing force in the predetermined direction is applied to the cell stacked body.

### BRIEF DESCRIPTION OF THE DRAWINGS

The objects, features, and advantages of the present invention will become clearer from the following description of embodiments in relation to the attached drawings, in which:

FIG. 1 is a perspective view schematically illustrating an overall configuration of a fuel cell stack according to an embodiment of the present invention;

FIG. 2 is a cross-sectional view taken along line II-II of FIG. 1;

FIG. 3 is a perspective view schematically illustrating a configuration of a unitized electrode assembly included in the fuel cell stack of FIG. 1;

FIG. 4 is a front view of a separator included in the fuel cell stack of FIG. 1;

FIG. 5 is an enlarged view of part V in FIG. 4; and

FIG. 6 is a cross-sectional view illustrating a main configuration of a power generation cell according to the embodiment of the present invention.

### DETAILED DESCRIPTION OF THE INVENTION

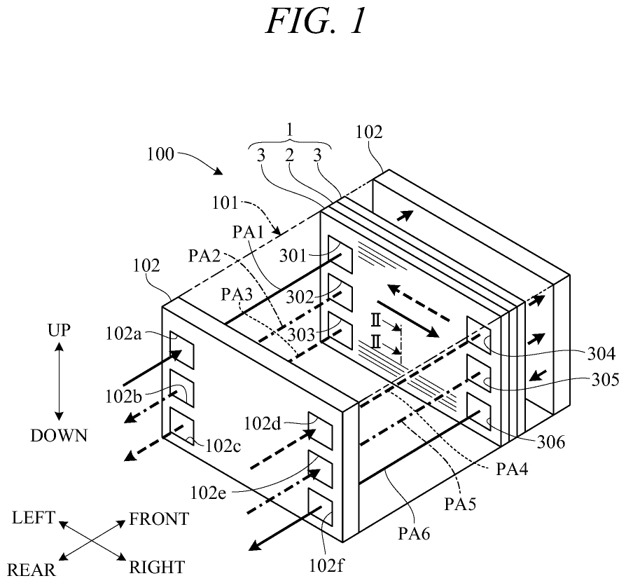

Hereinafter, embodiments of the present invention will be described with reference to FIGS. 1 to 6. A fuel cell stack according to an embodiment of the present invention is a main component of a fuel cell and constitutes a main body of the fuel cell. The fuel cell can be mounted on a vehicle, for example, and is capable of generating electric power for actuating the vehicle. First, the overall configuration of the fuel cell stack is schematically explained. The fuel cell stack may be simply referred to as a fuel cell.

FIG. 1 is a perspective view schematically illustrating an overall configuration of a fuel cell stack 100 according to an embodiment of the present invention. Hereinafter, for the sake of convenience, three-axis directions orthogonal to one another as illustrated in the drawings are defined as a front-rear direction, a left-right direction, and an up-down direction, and a configuration of each unit will be described in accordance with such definitions. The front-rear direction corresponds to a stacking direction of the fuel cell stack 100. The front-rear direction, the left-right direction, and the up-down direction may be the same as or different from the front-rear direction, the left-right direction, and the up-down direction of the vehicle.

As illustrated in FIG. 1, the fuel cell stack 100 includes a cell stacked body 101 configured by stacking a plurality of power generation cells 1 in the front-rear direction and end units 102 disposed at both end portions of the cell stacked body 101 in the front-rear direction, and the whole exhibits a substantially rectangular parallelepiped shape. Although not illustrated, the periphery of the cell stacked body 101 is covered by a substantially rectangular parallelepiped-shaped case. The length of the cell stacked body 101 in the left-right direction is longer than the length in the up-down direction. Therefore, the left-right direction is the longitudinal direction, and the up-down direction is the short direction. In FIG. 1, a single power generation cell 1 is shown for convenience.

The power generation cell 1 has a unitized electrode assembly 2 (hereinafter referred to as UEA) having a joined body including an electrolyte membrane and electrodes, and separators 3 disposed on both sides of the UEA 2 in the front-rear direction and sandwiching the UEA 2. The UEA 2 and the separators 3 are alternately arranged in the front-rear direction. The UEA 2 can also be referred to as a membrane electrode structure or a membrane electrode member.

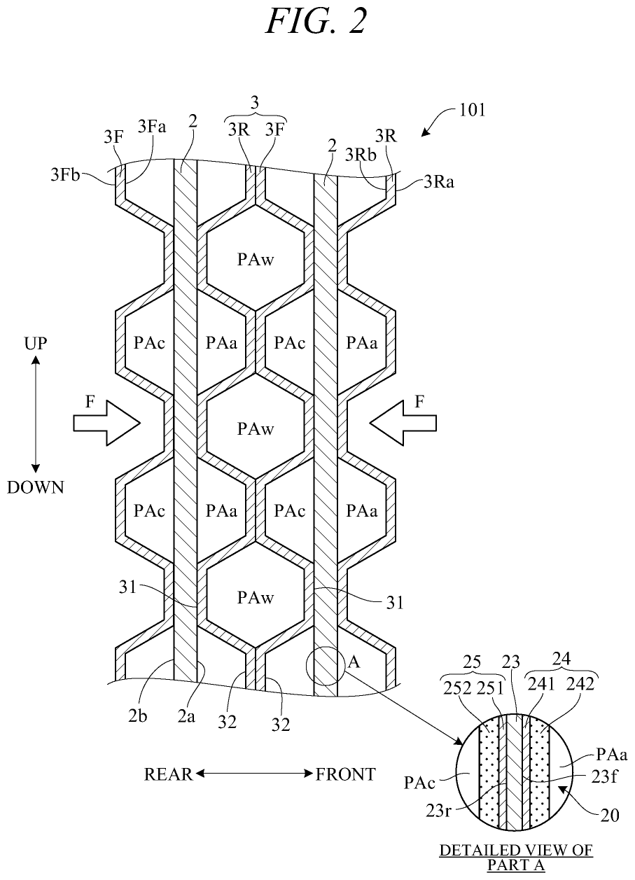

FIG. 2 is a cross-sectional view of a main part in a power generation region at the center of the cell stacked body 101 in the left-right direction (a cross-sectional view along line II-II in FIG. 1). As shown in FIG. 2, the separator 3 has a front plate 3F and a rear plate 3R, which are a pair of front and rear metallic thin plates having a corrugated cross-section. The front plate 3F extends in the up-down and left-right directions and has a front surface 3Fa and a rear surface 3Fb. The rear plate 3R extends in the up-down and left-right directions and has a front surface 3Ra and a rear surface 3Rb. The rear surface 3Fb of the front plate 3F and the front surface 3Ra of the rear plate 3R facing each other are joined at their outer peripheral edge portions by welding or the like. As a result, the front plate 3F and the rear plate 3R are integrally joined together. A conductive material having excellent corrosion resistance is used for the separator 3, and for example, stainless steel, titanium, titanium alloy, or the like can be used.

Inside the separator 3 surrounded by the front plate 3F and the rear plate 3R, that is, between the rear surface 3Fb of the front plate 3F and the front surface 3Ra of the rear plate 3R, a cooling flow path PAw through which a cooling medium flows is formed. The power generation surface of the power generation cell 1 is cooled by the flow of the cooling medium. As the cooling medium, for example, water can be used. The surfaces of the separator 3 facing the UEA 2 (the front surface 3Fa and the rear surface 3Rb) are configured in an uneven shape by press forming or the like so as to form gas flow paths with the UEA 2. More specifically, the separator 3 has a pair of front and rear convex portions 31 protruding toward the UEA 2 and a pair of front and rear concave portions 32 configured in a concave shape continuous with the pair of front and rear convex portions 31.

The pair of front and rear convex portions 31 abuts against the rear surface 2b and the front surface 2a of the UEA 2. A compressive load F is applied to the cell stacked body 101 in the front-rear direction during assembly of the fuel cell stack 100, and this compressive load F is maintained after completion of assembly of the fuel cell stack 100. Therefore, a predetermined surface pressure due to the compressive load F acts on the UEA 2 in the front-rear direction via the convex portions 31.

Between the front surface 2a of the UEA 2 and the rear plate 3R of the separator 3 facing the front surface 2a, an anode flow path PAa through which fuel gas flows is formed by the concave portion 32. Between the rear surface 2b of the UEA 2 and the front plate 3F of the separator 3 facing the rear surface 2b, a cathode flow path PAc through which oxidant gas flows is formed by the concave portion 32. The fuel gas is a gas containing hydrogen, and for example, hydrogen gas can be used. The oxidant gas is a gas containing oxygen, and for example, air can be used. Without distinguishing between the fuel gas and the oxidant gas, these may be referred to as reaction gas.

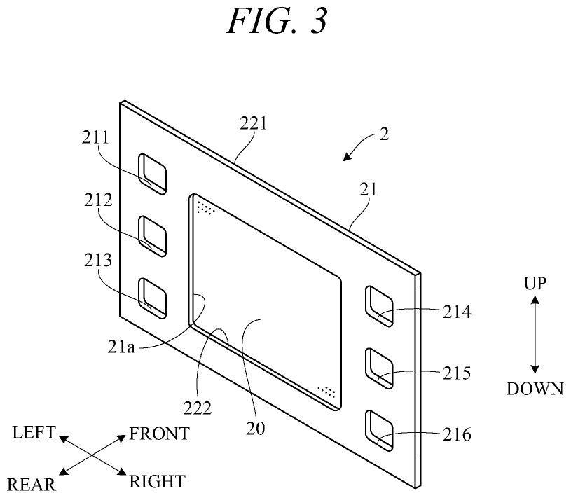

FIG. 3 is a perspective view illustrating a schematic configuration of the UEA 2. As shown in FIG. 3, the UEA 2 has a membrane electrode assembly (hereinafter referred to as MEA) 20 having a substantially rectangular shape and a frame 21 that supports the MEA 20. FIG. 2 includes a cross-sectional view of the MEA 20 as a cross-sectional view of the UEA 2. As illustrated in the detailed view of part “A” in FIG. 2, the MEA 20 has an electrolyte membrane 23, an anode electrode 24 provided on a front surface 23f of the electrolyte membrane 23, and a cathode electrode 25 provided on a rear surface 23r of the electrolyte membrane 23.

The electrolyte membrane 23 is, for example, a solid polymer electrolyte membrane, and a thin film of perfluorosulfonic acid polymer containing moisture can be used. Not only a fluorine-based electrolyte but also a hydrocarbon-based electrolyte can be used.

The anode electrode 24 has an electrode catalyst layer 241 formed on the front surface 23f of the electrolyte membrane 23 and serving as a reaction field for electrode reactions, and a gas diffusion layer 242 provided on the front surface of the electrode catalyst layer 241 and diffusing and supplying the fuel gas. The cathode electrode 25 has an electrode catalyst layer 251 formed on the rear surface 23r of the electrolyte membrane 23 and serving as a reaction field for electrode reactions, and a gas diffusion layer 252 provided on the rear surface of the electrode catalyst layer 251 and diffusing and supplying the oxidant gas.

Each of the electrode catalyst layers 241 and 251 includes a catalyst metal that promotes the electrochemical reaction of hydrogen contained in the fuel gas and oxygen contained in the oxidant gas, an electrolyte (such as an ionomer) with proton conductivity, and carbon particles with electronic conductivity. The gas diffusion layers 242 and 252 are composed of conductive members with gas permeability, such as carbon porous bodies.

In the anode electrode 24, the fuel gas (hydrogen) supplied through the anode flow path PAa is ionized by an action of the catalyst and moves to the cathode electrode side through the electrolyte membrane 23. Electrons generated at this time pass through an external circuit and are extracted as electric energy. In the cathode electrode 25, the oxidant gas (oxygen) supplied through the cathode flow path PAc reacts with hydrogen ions guided from the anode electrode 24 and electrons moved from the anode electrode 24, and water is generated. The generated water (referred to as generated water) provides appropriate humidity to the electrolyte membrane 23, and excess water is discharged to the outside of the UEA 2 along the gas flow. The generated water on the cathode side also flows to the anode side by back diffusion through the electrolyte membrane 23. Therefore, generated water is contained in both the fuel gas and the oxidant gas. The fuel gas and the oxidant gas also contain condensed water.

As illustrated in FIG. 3, the frame 21 is a substantially rectangular frame-shaped thin plate member having a predetermined thickness and is configured by a sheet material or film material of insulating resin, rubber, or the like. The frame 21 can also be referred to as a sheet, film, or gasket. A substantially rectangular opening 21a is provided in the central portion of the frame 21. The MEA 20 is provided so as to cover the entire opening 21a, and the peripheral portion of the MEA 20 is supported by the frame 21. The frame 21 has a substantially rectangular outer edge portion 221 and an inner edge portion 222. The outer edge portion 221 refers to the outer edge of the frame 21 and its peripheral portion, and the inner edge portion 222 refers to the inner edge of the frame 21 (the edge of the opening 21a) and its peripheral portion.

On the left side of the opening 21a of the frame 21, three through-holes 211 to 213 penetrating the frame 21 in the front-rear direction are opened side by side in the up-down direction. On the right side of the opening 21a, three through-holes 214 to 216 penetrating the frame 21 in the front-rear direction are opened side by side in the up-down direction. The through-holes 211 to 216 are all shown as substantially rectangular shapes for convenience, but the shapes and arrangements of the through-holes 211 to 216 are not limited to this.

As illustrated in FIG. 1, in the separators 3 in front of and behind the UEA 2, through-holes 301 to 306 penetrating the separators 3 in the front-rear direction are respectively opened at positions corresponding to the through-holes 211 to 216 of the frame 21. The through-holes 301 to 306 communicate with the through-holes 211 to 216 of the frame 21, respectively. By the collection of these mutually communicating through-holes 211 to 216 and 301 to 306, flow paths PA1 to PA6 (indicated by arrows for convenience) extending in the front-rear direction through the cell stacked body 101 are formed. The flow paths PA1 to PA6 are sometimes referred to as manifolds. The flow paths PA1 to PA6 are connected to manifolds external to the fuel cell stack 100.

Although not illustrated, the end units 102 at the front and rear of the cell stacked body 101 each have a plurality of plates disposed to overlap in the front-rear direction. That is, the end unit 102 has a terminal plate disposed adjacent to the cell stacked body 101, an insulating plate disposed on the outer side in the front-rear direction of the terminal plate, and an end plate disposed on the outer side in the front-rear direction of the insulating plate.

In the rear end unit 102, a plurality of through-holes 102a to 102f penetrating the end unit 102 in the front-rear direction are opened at positions corresponding to the through-holes 211 to 216 and 301 to 306 of the cell stacked body 101. The through-holes 102a to 102f are all shown as substantially rectangular shapes for convenience, but the positions and shapes of the through-holes 102a to 102f are not limited thereto.

The through-hole 102a is a fuel gas supply port, and fuel gas is supplied to the fuel cell stack 100 through the through-hole 102a. This fuel gas is guided to the anode flow path PAa between the UEA 2 and the rear plate 3R of the separator 3 through the through-holes 211 and 301. The fuel gas after passing through the anode flow path PAa flows rearward through the through-holes 216 and 306 and is discharged from the through-hole 102f.

The through-hole 102d is an oxidant gas supply port, and oxidant gas is supplied to the fuel cell stack 100 through the through-hole 102d. This oxidant gas is guided to the cathode flow path PAc between the UEA 2 and the front plate 3F of the separator 3 through the through-holes 214 and 304. The oxidant gas after passing through the cathode flow path PAc flows rearward through the through-holes 213 and 303 and is discharged from the through-hole 102c.

The through-hole 102e is a cooling medium supply port, and cooling medium is supplied to the fuel cell stack 100 through the through-hole 102e. This cooling medium is guided to the cooling flow path PAw between the front plate 3F and the rear plate 3R of the separator 3 through the through-holes 215 and 305. The cooling medium after passing through the cooling flow path PAw flows rearward through the through-holes 212 and 302 and is discharged from the through-hole 102b. The above is the schematic constitution of the fuel cell stack 100.

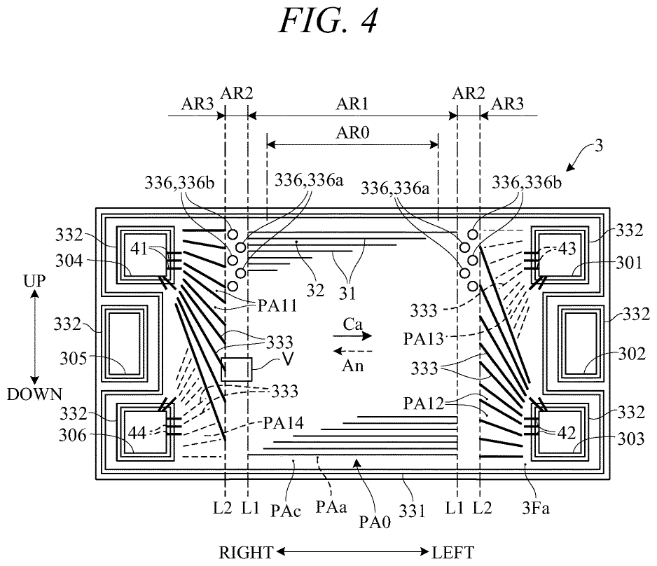

The configuration of the separator 3 will be described in more detail. FIG. 4 is a front view (view as viewed from the front side) of the separator 3, that is, a view illustrating a plan view of the separator 3, and in FIG. 4, the left-right direction is reversed with respect to FIG. 1. That is, FIG. 4 is a view illustrating the front surface 3Fa (FIG. 2) of the separator 3 facing the cathode electrode 25 on the rear surface 2b of the UEA 2. A positioning portion (e.g., an engagement concave portion) for positioning the separator 3 is provided at the peripheral edge portion of the separator 3, but illustration thereof is omitted in FIG. 4.

As illustrated in FIG. 4, the front surface 3Fa of the separator 3 (front plate 3F) is provided with a plurality of bead portions for sealing, that is, metal bead seal protruding toward the front side toward the frame 21. The plurality of bead portions includes an outer bead portion 331 and a plurality of individual bead portions 332. Although not illustrated, the plurality of bead portions is also provided on the rear plate 3R similarly to the front plate 3F.

The outer bead portion 331 extends in the left-right direction along the upper edge portion and the lower edge portion of the separator 3, and extends via the outer side in the left-right direction of the individual bead portion 332 at the periphery of the through-holes 301, 303, 304 and 306 and via the inner side in the left-right direction of the individual bead portion 332 at the periphery of the through-holes 302 and 305. The inner side in the left-right direction refers to the center side in the left-right direction of the separator 3, and the outer side in the left-right direction refers to the end portion side in the left-right direction of the separator 3. The plurality of individual bead portions 332 extend along the peripheral edge portions of the plurality of through-holes 301 to 306, and individually surround the plurality of through-holes 301 to 306.

In FIG. 4, in a region (central region) AR1 at the center in the left-right direction of the separator 3, although illustration of one part is omitted, a plurality of convex portions 31 are provided toward the front side at equal intervals in the up-down direction over substantially the entire region. Each of the plurality of convex portions 31 extends in the left-right direction, a concave portion 32 is provided between the convex portions 31 adjacent in the up-down direction, and a cathode flow path PAc (FIG. 2) is formed by the concave portion 32. Although not illustrated, the rear surface 3Rb of the rear plate 3R is also provided with the convex portion 31 and the concave portion 32 similarly to the front surface 3Fa of the front plate 3F, and the anode flow path PAa (FIG. 2) is formed by the concave portion 32.

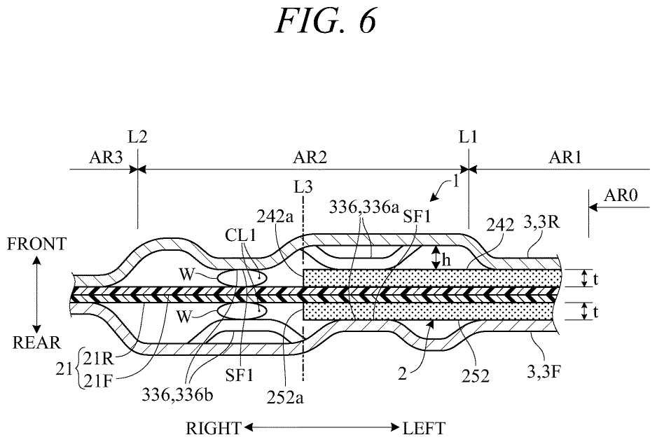

A power generation region AR0 that generates power by an electrochemical reaction between hydrogen contained in the fuel gas and oxygen contained in the oxidant gas is provided on the inner side in the left-right direction of the central region AR1. On the outer side of the power generation region AR0 in the central region AR1, the inner edge portion 222 of the frame 21 overlaps the peripheral edge portion of the MEA 20 (see FIG. 6), and power generation is not performed. A buffer region AR2 adjacent to the central region is provided on the outer side in the left-right direction of the central region AR1, and an end portion region AR3 is provided on the outer side in the left-right direction of the buffer region AR2. FIG. 4 illustrates a boundary line L1 between the central region AR1 and the buffer region AR2 and a boundary line L2 between the buffer region AR2 and the end portion region AR3.

The end portion region AR3 is a region between the through-holes 301 to 306 and the boundary line L2. In an end portion region AR3 on the right side of the front surface 3Fa of the separator 3, a plurality of guide portions 333 are provided to protrude toward the frame 21 on the front side from the through-hole 304 over the entire region in the up-down direction of the buffer region AR2 continuing to the right end inlet of the cathode flow path PAc. The plurality of guide portions 333 extend substantially at equal intervals and substantially parallel to each other, and obliquely extend toward the left side or the lower left side. An oxidant gas supply flow path PA11 for supplying oxidant gas is formed in a space facing the frame 21 between the guide portions 333 adjacent in the up-down direction. A tunnel portion 41 of a cavity extending so as to intersect the individual bead portion 332 is provided at the peripheral edge of the through-hole 304. The through-hole 304 and the oxidant gas supply flow path PA11 communicate with each other via the tunnel portion 41.

In an end portion region AR3 on the left side of the front surface 3Fa of the separator 3, a plurality of guide portions 333 are provided to protrude toward the frame 21 on the front side from the entire region in the up-down direction of the buffer region AR2 continuing to the left end outlet of the cathode flow path PAc to the through-hole 303. The plurality of guide portions 333 extend substantially at equal intervals and substantially parallel to each other, and obliquely extend toward the left side or the lower left side. An oxidant gas discharge flow path PA12 for discharging oxidant gas is formed in a space facing the frame 21 between the guide portions 333 adjacent in the up-down direction. A tunnel portion 42 of a cavity extending so as to intersect the individual bead portion 332 is provided at the peripheral edge of the through-hole 303. The through-hole 303 and the oxidant gas discharge flow path PA12 communicate with each other via the tunnel portion 42.

Similarly, the guide portion 333 is provided to protrude toward the rear side in the end portion region AR3 on the left side and the end portion region AR3 on the right side of the rear surface 3Rb of the separator 3. A fuel gas supply flow path PA13 for supplying fuel gas is formed in the end portion region AR3 on the left side, and a fuel gas discharge flow path PA14 for discharging fuel gas is formed in the end portion region AR3 on the right side. A tunnel portion 43 is provided at a peripheral edge of the through-hole 301, and the through-hole 301 and the fuel gas supply flow path PA13 communicate with each other via the tunnel portion 43. A tunnel portion 44 is provided at a peripheral edge of the through-hole 306, and the through-hole 306 and the fuel gas discharge flow path PA14 communicate with each other via the tunnel portion 44.

The configurations of the left and right buffer regions AR2 are equal to each other. In the buffer region AR2 of the separator 3 (front plate 3F), although illustration of one part is omitted, a plurality of convex portions 336 having a substantially cylindrical shape are provided to protrude toward the front side over the entire region in the up-down direction. The plurality of convex portions 336 have the same shape and include a plurality of inner convex portions 336a arranged on the inner side in the left-right direction and a plurality of outer convex portions 336b arranged on the outer side in the left-right direction. The plurality of inner convex portions 336a and the plurality of outer convex portions 336b are provided at equal intervals in the up-down direction. The distance between the pair of inner convex portions 336a adjacent in the up-down direction is equal to the distance between the pair of outer convex portions 336b adjacent in the up-down direction.

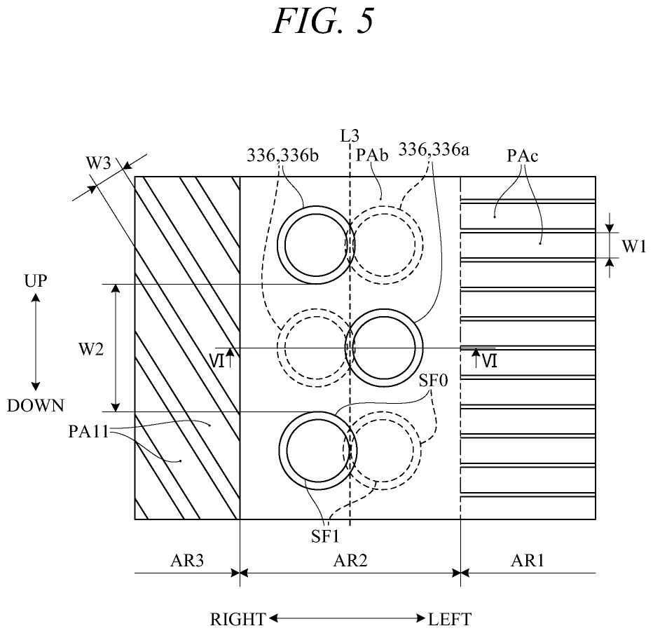

FIG. 5 is an enlarged view (enlarged view of portion V in FIG. 4) of the buffer region AR2 on the right side in FIG. 4. FIG. 5 illustrates not only the convex portion 336 (solid line) of the front plate 3F but also the convex portion 336 (dotted line) of the rear plate 3R. As illustrated in FIG. 5, the plurality of inner convex portions 336a and the plurality of outer convex portions 336b are provided with the positions shifted from each other in the up-down direction. More specifically, the inner convex portion 336a is provided at an intermediate position in the up-down direction of the pair of outer convex portions 336b adjacent in the up-down direction. In other words, the plurality of inner convex portions 336a and the plurality of outer convex portions 336b are provided at the same predetermined pitch interval in the up-down direction, and the plurality of inner convex portions 336a are provided to be shifted in position by a half pitch in the up-down direction with respect to the plurality of outer convex portions 336b. Therefore, the plurality of convex portions 336 are entirely arrayed in a staggered manner.

Strictly speaking, the plurality of convex portions 336 have a substantially truncated cone shape, and the area of the top surface SF1 of the convex portion 336 is smaller than the area of the bottom surface SF0. If a line extending in the up-down direction through the middle of the buffer region AR2 in the left-right direction is defined as an intermediate line L3, the top surface SF1 of the inner convex portion 336a is located on the inner side (left side) of the intermediate line L3, and the top surface SF1 of the outer convex portion 336b is located on the outer side (right side) of the intermediate line L3. The bottom surface SF0 of the inner convex portion 336a and the bottom surface SF0 of the outer convex portion 336b intersect the intermediate line L3.

The convex portion 336 (dotted line) of the rear plate 3R is provided to be shifted in position by a half pitch in the up-down direction with respect to the convex portion 336 (solid line) of the front plate 3F. As a result, the convex portion 336 of the front plate 3F and the convex portion 336 of the rear plate 3R are arranged side by side in the left-right direction. The convex portion 336 of the rear plate 3R and the convex portion 336 of the front plate 3F may be provided at the same position in the up-down and left-right directions. That is, the separator 3 may be provided such that the convex portion 336 of the front plate 3F and the convex portion 336 of the rear plate 3R overlap each other in a plan view in which the separator 3 is viewed from the thickness direction.

The length between the inner convex portions 336a adjacent in the up-down direction and the length between the outer convex portions 336b adjacent in the up-down direction of each of the front plate 3F and the rear plate 3R correspond to the width W2 of the flow path (buffer flow path PAb) of the oxidant gas in the buffer region AR2. The width W3 of the oxidant gas supply flow path PA11 in the end portion region AR3 is wider than the width W1 of the cathode flow path PAc in the central region AR1, but narrower than the width W2 of the buffer flow path PAb in the buffer region AR2. Therefore, the buffer region AR2 constitutes an enlarged region in which the flow path width of the oxidant gas is enlarged.

By providing the buffer region AR2, the distribution in the flow of the oxidant gas in the up-down direction becomes uniform, and the oxidant gas can be guided to the entire region of the cathode flow path PAc. The cathode flow path PAc, the oxidant gas supply flow path PA11, the oxidant gas discharge flow path PA12, and the buffer flow path PAb constitute a gas flow path PA0 (FIG. 4) between the front plate 3F of the separator 3 and the UEA 2. The anode flow path PAa, the fuel gas supply flow path PA13, the fuel gas discharge flow path PA14, and the buffer flow path PAb constitute a gas flow path PA0 between the rear plate 3R of the separator 3 and the UEA 2.

FIG. 6 is a cross-sectional view (cross-sectional view taken along line VI-VI in FIG. 5) illustrating a configuration of a main part of a power generation cell 1 according to the example embodiment of the present invention. FIG. 6 is a cross-sectional view mainly illustrating a configuration of the buffer region AR2 of the power generation cell 1, and FIG. 6 also illustrates the convex portion 336 on a far side (upper side in FIG. 5) than the cross-section. As illustrated in FIG. 6, the frame 21 is configured by adhering the front frame 21F, and the rear frame 21R. The frame 21 extends to the left side beyond the boundary line L1 between the buffer region AR2 and the central region AR1. Although not illustrated, the left end (inner edge) of the frame 21 is located on the right side of the power generation region AR0. The left end position of the front frame 21F and the left end position of the rear frame 21R are different, and for example, the left end of the front frame 21F is located on the left side of the left end of the rear frame 21R. Therefore, there is a step difference at the left end portion (inner edge portion 222) of the frame 21.

The right end face 242a (outer edge) of the anode-side gas diffusion layer 242 and the right end face 252a of the cathode-side gas diffusion layer 252 are located at the same position in the left-right direction. For example, it is located on the intermediate line L3 of the buffer region AR2. In buffer region AR2, an electrolyte membrane 23 and electrode catalyst layer 241 and 251 in FIG. 2 do not exist, and the surface of the gas diffusion layers 242 and 252 is in close contact with the frame 21. Although not illustrated, the gas diffusion layers 242 and 252 extend toward the left side beyond the power generation region AR0. The right end of the electrolyte membrane 23 is located at a position (power generation start position) where the power generation region AR0 is started. One of the electrode catalyst layers 241 and 251 (for example, electrode catalyst layer 241) is also located at the power generation start position. The other of the electrode catalyst layers 241 and 251 (for example, electrode catalyst layer 251) extends toward the right side beyond the power generation start position and faces the step difference of the inner edge portion 222 of the frame 21.

The positions of the end faces (right end faces 242a and 252a and left end face) of the gas diffusion layers 242 and 252 vary within a range of manufacturing errors. In the present exemplary embodiment, the power generation cell 1 is configured such that the positions of the right end faces 242a and 252a of the gas diffusion layers 242 and 252 are located within at least the buffer region AR2. Specifically, the end portion positions of the gas diffusion layers 242 and 252 are located on the intermediate line L3. Thus, since the intermediate line L3 and the boundary lines L1 and L2 are apart from each other by a predetermined distance, the power generation cell 1 can be configured such that the positions of the right end faces 242a and 252a do not go beyond the boundary line L2 even if the right end faces 242a and 252a of the gas diffusion layers 242 and 252 are shifted toward the right side, and the positions of the right end faces 242a and 252a do not go beyond the boundary line L1 even if right end faces 242a and 252a of the gas diffusion layers 242 and 252 are shifted toward the left side.

The separator 3 is formed in the buffer region AR2 such that top surface SF1 of the convex portion 336 is spaced apart from the frame 21 by an amount corresponding to a thickness (predetermined length t) of the gas diffusion layers 242 and 252. That is, the separator 3 is formed such that the protruding length (height h) of the convex portion 336 is shorter than the protruding length of the convex portion 31 (FIG. 2) of the separator 3 by a predetermined length t.

By setting the height h of the convex portion 336 in this manner, when the end portion positions of the gas diffusion layers 242 and 252 are located on the intermediate line L3, the top surface SF1 of the inner convex portion 336a abuts on the surfaces of the gas diffusion layers 242 and 252. Therefore, no gap is generated between the inner convex portion 336a and the surface of the frame 21. On the other hand, a gap CL1 having a predetermined length t is generated between the top surface SF1 of the outer convex portion 336b and the surface of the frame 21. Therefore, generated water W may retain in the gap CL1.

That is, in the UEA 2, a step difference is generated at the end portions (end faces) in the left-right direction of the gas diffusion layers 242 and 252. Thus, a gap is generated between the separator 3 and the frame 21 at the periphery of the gas diffusion layers 242 and 252, specifically, on the right side of the right end faces 242a and 252a of the gas diffusion layers 242 and 252. If the gap is large, the generated water is discharged together with the flow of the reaction gas, and hence the generated water is not retained. However, since the end portion positions of the gas diffusion layers 242 and 252 vary, a region with a small gap may be generated. In FIG. 6, the gap CL1 between the top surface SF1 of the outer convex portion 336b and the frame 21 is small. Therefore, generated water W may retain in the gap CL1.

In the present embodiment, in the buffer region AR2, a plurality of convex portions 336 having a substantially cylindrical shape (embossed shape), more specifically, a substantially truncated conical shape are provided in two columns in the left-right direction and at a predetermined pitch in the up-down direction. Therefore, the area of the region where the gap CL1 is small, that is, the area of the top surface SF1 is small, as compared with a case where a protruding portion other than the substantially cylindrical shape, for example, a protruding portion having a flow path shape extending in the left-right direction (a protruding portion forming a branched flow path or a merged flow path) is provided. As a result, the amount of generated water retained between the separator 3 and the frame 21 can be reduced.

Although not illustrated, when the positions of the right end faces 242a and 252a of the gas diffusion layers 242 and 252 are shifted to the right side of the outer convex portion 336b within a range not going beyond the boundary line L2, not only the inner convex portion 336a but also the top surface SF1 of the outer convex portion 336b abut on the surface of the gas diffusion layers 242 and 252. In this case, there is no region where the gap CL1 becomes small, and the amount of generated water retaining between the separator 3 and the frame 21 can be minimized.

On the other hand, when the positions of the right end faces 242a and 252a of the gas diffusion layers 242 and 252 are shifted to the left side of the inner convex portion 336a within the range not going beyond the boundary line L1, the gap CL1 is generated not only between the outer convex portion 336b and the frame 21 but also between the inner convex portion 336a and the frame 21. Therefore, although the retained amount of generated water is increased as compared with the case of FIG. 6, the entire area of the portion (top surface SF1) where the gap CL1 is generated is small because the convex portions 336 are arranged at a predetermined pitch in the up-down direction. As a result, the retained amount of generated water at the periphery of the right end faces 242a and 252a of the gas diffusion layers 242 and 252, that is, the periphery of the step difference of the UEA 2 can be sufficiently suppressed.

According to the present embodiment, the following operations and effects can be achieved.
(1) The power generation cell 1 includes an UEA 2 and a separator 3 (FIG. 1). The UEA 2 includes: an MEA 20 having an electrolyte membrane 23, an anode electrode 24 disposed along a front surface 23f of the electrolyte membrane 23, and a cathode electrode 25 disposed along a rear surface 23r of the electrolyte membrane 23; and a frame 21 supporting a peripheral edge portion of the MEA 20 (FIGS. 2 and 3). The separator 3 includes a rear plate 3R that is disposed facing the front surface 2a of the UEA 2 and forms a gas flow path PA0 with the UEA 2 through which flow path the fuel gas flows, and a front plate 3F that is disposed facing the rear surface 2b of the UEA 2 and forms a gas flow path PA0 with the UEA 2 through which flow path the oxidant gas flows (FIGS. 2 and 4). The anode electrode 24 includes a gas diffusion layer 242 to which the fuel gas is supplied, and an electrode catalyst layer 241 disposed between the electrolyte membrane 23 and the gas diffusion layer 242, and the cathode electrode 25 includes a gas diffusion layer 252 to which the oxidant gas is supplied, and an electrode catalyst layer 251 disposed between the electrolyte membrane 23 and the gas diffusion layer 252 (FIG. 2). The gas flow paths PA0 for the anode and the cathode include an anode flow path PAa and a cathode flow path PAc, respectively, formed in the central region AR1 of the separator 3 and extending in the left-right direction, a buffer flow path PAb formed in the buffer region AR2 adjacent to the central region AR1, and supply and discharge flow paths of a reaction gas formed in the end portion region AR3 between the through-holes 301, 303, 304 and 306 penetrating the separator 3 and the buffer region AR2, that is, a fuel gas supply flow path PA13, a fuel gas discharge flow path PA14, an oxidant gas supply flow path PA11, and an oxidant gas discharge flow path PA12 (FIG. 4). Each of the front plate 3F and the rear plate 3R has a plurality of convex portions 336 having a predetermined height h of a substantially cylindrical shape protruding from each of the front plate 3F and the rear plate 3R toward the UEA 2 in the buffer region AR2 (FIG. 4). The predetermined height h is set such that the plurality of convex portions 336 are spaced apart from the frame 21 by an amount corresponding to the thickness t of the gas diffusion layers 242 and 252, and the end portions (right end faces 242a and 252a) of the gas diffusion layers 242 and 252 are located in the buffer region AR2 (FIG. 6).

Since a step difference is generated in the UEA 2 at the periphery of the end portions of the gas diffusion layers 242 and 252, a minute gap is likely to be generated between the separator 3 and the frame 21 of the UEA 2, and generated water may be retained in the gap. In this regard, in the present embodiment, the minute gap CL1 is generated between the convex portion 336 of the separator 3 and the frame 21, but the entire area of the convex portion 336 is small. As a result, the amount of generated water retained can be reduced, and deterioration of the electrolyte membrane 23 can be suppressed.
(2) The plurality of convex portions 336 include a plurality of inner convex portions 336a arranged along a boundary line L1 which is a boundary between the central region AR1 and the buffer region AR2, and a plurality of outer convex portions 336b arranged along a boundary line L2 which is a boundary between the buffer region AR2 and the end portion region AR3 (FIG. 4). By providing the two left and right columns of convex portions 336 in the buffer region AR2 in this manner, the end portions of the gas diffusion layers 242 and 252 can be satisfactorily supported even if the end portion positions of the gas diffusion layers 242 and 252 vary in the left and right direction.
(3) The plurality of inner convex portions 336a and the plurality of outer convex portions 336b are arranged in a staggered pattern in plan view in which the power generation cell 1 is viewed from the front-rear direction which is the thickness direction of the power generation cell 1 (FIG. 4). As a result, the flow of the reaction gas can be satisfactorily made uniform in the buffer region AR2.
(4) The end portions of the gas diffusion layers 242 and 252 are disposed along the intermediate line L3 passing through a middle between the boundary line L1 and the boundary line L2 (FIG. 6). As a result, the end portion positions of the gas diffusion layers 242 and 252 having variations in the left-right direction can be located in the buffer region AR2.
(5) A fuel cell stack 100 includes a cell stacked body 101 formed by stacking the power generation cells 1 described above in the front-rear direction, and an end unit 102 that is disposed around the cell stacked body 101 and holds the cell stacked body 101 while applying a pressurization force in the front-rear direction to the cell stacked body 101 (FIG. 1). In such a fuel cell stack 100, the minute gap CL1 is generated between the separator 3 and the frame 21 at around the end portions of the gas diffusion layers 242 and 252 of the power generation cell 1, and the generated water may retain in the gap CL1. In this regard, in the present embodiment, the retained amount of generated water can be reduced since the area of the gap CL1 in the entire buffer region is small.

The above embodiment can be modified to various forms. Hereinafter, some modified examples will be described. In the above embodiment, the MEA 20 (a membrane electrode assembly) is configured by disposing the anode electrode 24 (a first gas diffusion electrode layer) on the front surface 23f which is one surface of the electrolyte membrane 23, and the cathode electrode 25 (a second gas diffusion electrode layer) on the rear surface 23r which is the other surface, but the cathode electrode 25 may be disposed on one surface and the anode electrode 24 may be disposed on the other surface. In the above embodiment, the UEA 2 (a membrane electrode structure) is configured by supporting the peripheral portion of the MEA 20 with the frame 21 as a frame member, but the configuration of the membrane electrode structure is not limited to that described above. In the above embodiment, the gas flow path PA0 (a first flow path) through which the fuel gas (a first reaction gas) flows is formed between the rear plate 3R as a first separator and the UEA 2, and the gas flow path PA0 (a second flow path) through which the oxidant gas (a second reaction gas) flows is formed between the front plate 3F as a second separator and the UEA 2, but the first reaction gas may be oxidant gas and the second reaction gas may be fuel gas.

In the above embodiment, the anode electrode 24 as a first gas diffusion electrode layer is configured by the gas diffusion layer 242 (a first gas diffusion layer) and the electrode catalyst layer 241 (a first electrode catalyst layer), and the cathode electrode 25 as a second gas diffusion electrode layer is configured by the gas diffusion layer 252 (a second gas diffusion layer) and the electrode catalyst layer 251 (second electrode catalyst layer), but the configurations of the first gas diffusion electrode layer and the second gas diffusion electrode layer are not limited to those described above. In the above embodiment, the anode flow path PAa and the cathode flow path PAc as a central flow path are formed in the central region AR1 (a first region are the separator 3, the buffer flow path PAb as an adjacent flow path is formed in the buffer region AR2 adjacent to the central region AR1, and the fuel gas supply flow path PA13, the fuel gas discharge flow path PA14, the oxidant gas supply flow path PA11, and the oxidant gas discharge flow path PA12 as an end flow path are formed in the end portion region AR3 (a third region) between the through-holes 301, 303, 304 and 306 (communication holes) for gas supply and discharge and the buffer region AR2, but the configuration of the gas flow path PA0 is not limited to that described above. The central flow path is a flow path provided in the power generation region AR0, and the central flow path may be referred as a power generation flow path. In the above embodiment, the power generation region AR0 is formed inside the central region AR1, but the central region AR1 and the power generation region AR0 may be made to coincide.

In the above embodiment, in the buffer region AR2, substantially cylindrical, more specifically substantially truncated cone-shaped convex portions 336 are provided to protrude from each of the front plate 3F and the rear plate 3R of the separator 3 toward the UEA 2, but the configuration of a protruding portion is not limited to that described above. In the above embodiment, the height h (predetermined height) of the convex portions 336 is set so that the convex portions 336 are spaced apart from the frame 21 by an amount corresponding to the thickness t of the gas diffusion layers 242 and 252, but the predetermined height is not limited to that described above. In the above embodiment, the right end faces 242a and 252a (an end portion) of the gas diffusion layers 242 and 252 are arranged along the intermediate line L3 passing through the middle between the boundary line L1 (a first boundary line) which is the boundary of the regions AR1 and AR2 and the boundary line L2 (a second boundary line) which is the boundary of the regions AR2 and AR3, but they may be arranged offset from the intermediate line L3.

In the above embodiment, the plurality of convex portions 336 are configured by a plurality of inner convex portions 336a (first protruding portions) arranged along the boundary line L1, that is, in the vicinity of the boundary line L1 and substantially parallel to the boundary line L1, and a plurality of outer convex portions 336b (second protruding portions) arranged along the boundary line L2, that is, in the vicinity of the boundary line L2 and substantially parallel to the boundary line L2, but the configuration of the protruding portion is not limited thereto. That is, the protruding portion in the second region may be in one row or three or more rows instead of two rows in the left-right direction. In the above embodiment, the plurality of convex portions 336 are arranged in a staggered pattern in a plan view of the power generation cell 1, but the arrangement of the protruding portions does not have to be staggered. In the above embodiment, the fuel cell stack 100 is configured by applying pressure to the cell stacked body 101 with the pair of front and rear end units 102, but the configuration of the fuel cell stack having a cell stacked body and an end unit is not limited to that described above.

In the above embodiment, an example in which the fuel cell stack 100 is applied to a vehicle is described, but the fuel cell stack having the power generation cell of the present invention can also be applied to mobile bodies other than vehicles such as aircraft and ships, robots, and various industrial machines.

The above embodiment can be combined as desired with one or more of the above modifications. The modifications can also be combined with one another.

According to the present invention, an amount of generated water that stagnates can be reduced, and deterioration of an electrolyte membrane can be suppressed.

Above, while the present invention has been described with reference to the preferred embodiments thereof, it will be understood, by those skilled in the art, that various changes and modifications may be made thereto without departing from the scope of the appended claims.

What is claimed is:

1. A power generation cell comprising:
a membrane electrode structure including a membrane electrode assembly and a frame member supporting a peripheral edge portion of the membrane electrode assembly, the membrane electrode assembly having an electrolyte membrane, a first gas diffusion electrode layer disposed along one surface of the electrolyte membrane, and a second gas diffusion electrode layer disposed along another surface of the electrolyte membrane; and
a separator including a first separator and a second separator, the first separator being disposed facing one surface of the membrane electrode structure so as to form a first flow path through which a first reaction gas flows between the first separator and the membrane electrode structure, the second separator being disposed facing another surface of the membrane electrode structure so as to form a second flow path through which a second reaction gas flows between the second separator and the membrane electrode structure, wherein
the first gas diffusion electrode layer includes a first gas diffusion layer to which the first reaction gas is supplied, and a first electrode catalyst layer disposed between the electrolyte membrane and the first gas diffusion layer,
the second gas diffusion electrode layer includes a second gas diffusion layer to which the second reaction gas is supplied, and a second electrode catalyst layer disposed between the electrolyte membrane and the second gas diffusion layer,
each of the first flow path and the second flow path includes a central flow path formed in a first region located at a central portion of the separator, an adjacent flow path formed in a second region adjacent to the first region, and an end flow path formed in a third region between a communication hole for a gas supply and discharge penetrating the separator and the second region,
each of the first separator and the second separator has a plurality of protruding portions having a predetermined height of a substantially cylindrical shape protruding from each of the first separator and the second separator toward the membrane electrode structure in the second region,
the predetermined height is set such that the plurality of protruding portions are spaced apart from the frame member by an amount corresponding to a thickness of each of the first gas diffusion layer and the second gas diffusion layer, and
an end portion of the first gas diffusion layer and an end portion of the second gas diffusion layer are located within the second region.

2. The power generation cell according to claim 1, wherein
the plurality of protruding portions include a plurality of first protruding portions disposed along a first boundary line defined as a boundary line between the first region and the second region, and a plurality of second protruding portions disposed along a second boundary line defined as a boundary line between the second region and the third region.

3. The power generation cell according to claim 2, wherein
the plurality of first protruding portions and the plurality of second protruding portions are arranged in a staggered pattern in a plan view of the power generation cell.

4. The power generation cell according to claim 2, wherein
the end portion of the first gas diffusion layer and the end portion of the second gas diffusion layer are arranged along an intermediate line passing through a middle between the first boundary line and the second boundary line.

5. The power generation cell according to claim 1, wherein
the plurality of protruding portions have a substantially truncated cone shape.

6. The power generation cell according to claim 1, wherein
a flow path width of the adjacent flow path is wider than a flow path width of the central flow path and wider than a flow path width of the end flow path.

7. A fuel cell stack comprising:
a cell stacked body including a plurality of the power generation cells according to claim 1 stacked in a predetermined direction; and
an end unit disposed around the cell stacked body and configured to hold the cell stacked body in a state where a pressing force in the predetermined direction is applied to the cell stacked body.
